(19) United States
(12) Patent Application Publication
(10) Pub. No.: US 2005/0103614 A1
(43) Pub. Date: May 19, 2005

(54) Wet/dry distiller

(76) Inventor: Chiang Chuan Cheng, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/714,618

(22) Filed: Nov. 18, 2003

(51) Int. Cl. B01D 3/00; C10B 9/00

(52) U.S. Cl. 202/163; 202/189

(57) ABSTRACT

A wet/dry distiller consists of an upper pot and a lower pot both of which are hollow and the upper pot is placed above the lower pot. The lower pot includes a base mounted at its bottom so as to form a receiving space. A cone is disposed around the surroundings of the inner sidewall of the upper pot so as to divide the inner space of the upper pot into an upper receiving chamber and a lower receiving chamber both of which are incommunicable. The upper receiving chamber is used to accommodate cooling water and the lower receiving chamber is communicable with the receiving space of the lower pot. An inclined annulation is disposed around the surroundings of the inner sidewall of the lower receiving chamber of the upper pot so as to form a collecting tank to collect distillate. A valve is disposed on the outer sidewall of the upper pot and is adjacent to the collecting tank.

### FIELD OF THE INVENTION

The present invention is related to a dual-purpose distiller. More-particularly, the present invention is related to a distiller that can prevent the vaporized steam from leaking away during the distillation process and is adaptable to wet/dry distillation process.

### BACKGROUND OF THE INVENTION

Wine-making is conceived as a traditional industry in most part of the world, and the wine-making equipment has been incessantly developed and upgraded. Wine-making technique is also conceived as an antique technology. The principle of making wine by distillation is to continuously heat the dreggy wine to its boiling point so as to evaporate the alcoholic ingredient thereof into steam, collect the vaporized steam, and allow the vaporized steam to undergo heat exchange process so that the vaporized steam can be condensed into liquid. The above steps are repeated iteratively so that the alcoholic ingredient can be distilled gradually from the dreggy wine so as to brew purified wine liquid.

As shown in FIG. 1, a conventional distiller is comprised, of a heating pot 10 and a cooling pot 20. The heating pot 10 is covered with a pot lid 15 with a conduit 17 connected thereto. A discharge exit 19 of the conduct 17 passes through the pot lid 25 and is fixedly mounted on the outer sidewall at the bottom of the cooling pot 20. The conduit 17 is circuitously placed in the interior of the cooling pot. When a user desires to proceed with distillation, the distillation steps are as follows: pouring dreggy wine 27 to be distilled into the heating pot 10 and covering the heating pot with the pot lid 15, and injecting cooling water into the cooling pot 20. When the temperature of heating pot 10 is heated up to a certain degree, the alcoholic ingredient of the dreggy wine 27 is gradually sublimated to wine steam 29. The wine steam 29 will diffuse through the conduit 17 and conduct heat exchange with the cooling water in the cooling pot 20 so as to be condensed into wine liquid. The wine liquid is then discharged and collected through the discharge exit 19 of the conduit 17 so as to produce distilled wine.

As shown, the ordinary design of a wine-making distiller is prone to let the wine steam to leak from the chinks between the heating pot 10 and the pot lid 15, as indicated by the arrows. The total amount of wine brewed by the distillation process will be reduced and the effect of distillation is debased. Further, due to the chinks between the heating pot 10 and the pot lid 15, the wine steam will leak away and the heating efficiency in the distillation process will be degraded, so that the heating time for distillation will be prolonged and the cost of distillation will be raised.

In view of the foregoing drawbacks, the present invention provides a wet/dry distiller that can remove the 2. drawbacks encountered by the prior art and is advantageous in terms of better efficiency in the distillation process, reduced heating time for distillation, and adaptability to wet/dry distillation process.

### SUMMARY OF THE INVENTION

A first object of the present invention is to provide a wet/dry distiller that can prevent the heated wine steam from leaking away.

Another object of the present invention is to provide a wet/dry distiller that can improve the heating efficiency in the distillation process, reduce heating time for distillation, and enhance the heating efficiency in the distillation process.

Another yet object of the present invention is to provide a dual-purpose distiller that is operable in wet/dry distillation process.

The present invention is attained by a wet/dry distiller including an upper pot and a lower pot both of which are shaped into a hollow columnar body, the upper pot includes a cone disposed around the surroundings of the inner sidewall of the upper pot so as to divide its inner space into an upper receiving chamber and a lower receiving chamber, wherein the upper receiving chamber and the lower receiving chamber are incommunicable with each other, wherein the upper receiving chamber contains cooling water and an inclined annulation is disposed around the surroundings of the inner sidewall of the lower receiving chamber of the upper pot so as to form a collecting tank, and a discharge exit is disposed on the outer sidewall of the upper pot and is adjacent to the collecting tank. The lower pot is placed below the upper pot with a base mounted at its bottom, wherein a receiving space is formed in the interior of the lower pot, and the receiving space is communicable with the lower receiving chamber of the upper pot.

The foregoing and features and advantages of the present invention will become more apparent through the following descriptions with reference to the accompanying drawings, in which:

### BRIEF DESCRIPTION OF THE DRAWINGS

FIG. 1 shows the outlined structure of a conventional distiller;

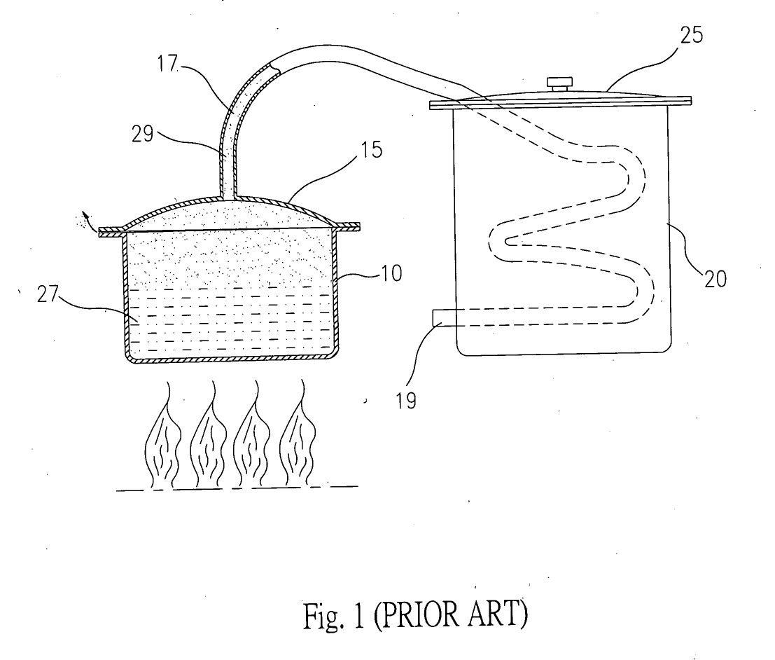

FIG. 2 shows a cubic view of a distiller according to the present invention;

FIG. 3 show a cross-sectional view of a distiller according to the present invention;

FIG. 4 shows a distiller according to the present invention being used in dry distillation process; and

FIG. 5 shows a distiller according to the present invention being used in wet distillation process.

### DETAILED DESCRIPTION OF THE PREFERRED EMBODIMENT

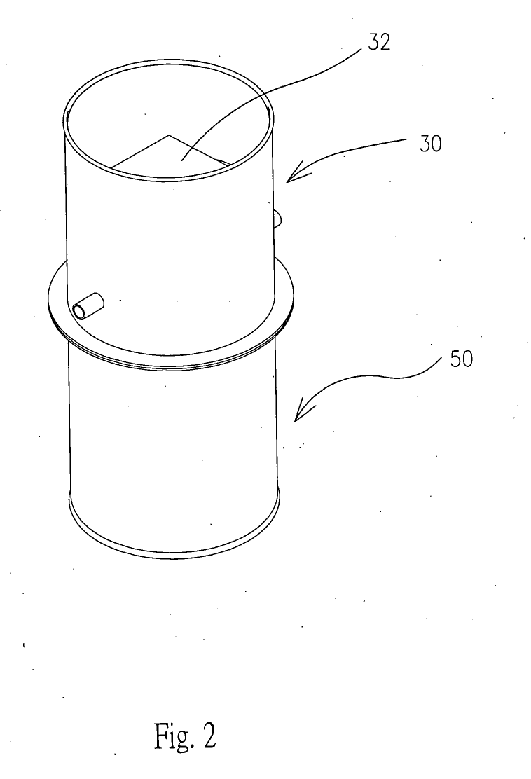

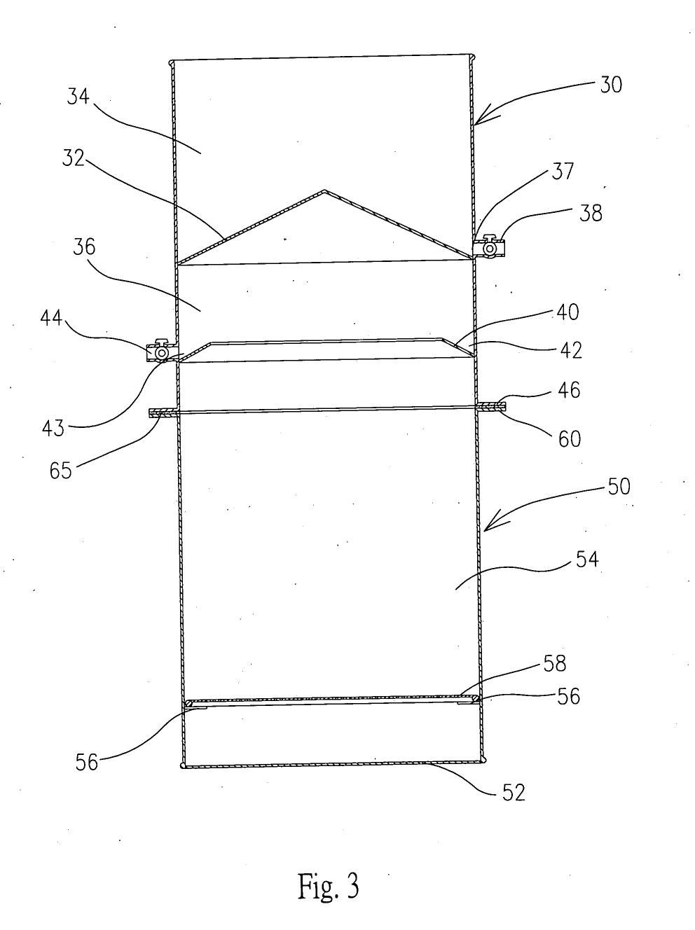

FIGS. 2 and 3 respectively show a cubic view and a cross-sectional view of a distiller according to a preferred embodiment of the present invention. As shown, the distiller according to a preferred embodiment of the present invention includes an upper pot 30 and a lower pot 50 both of which are shaped as a hollow cylinder. However, their appearances are not limited to cylindrical. A cone 32 is disposed around the surroundings of the inner sidewall of the upper pot 30 so that the inner space of the upper pot 30 is divided into an upper receiving chamber 34 and a lower receiving chamber 36 thereby. A discharge exit 37 is disposed at the bottom of the outer sidewall of the upper receiving chamber 34, and a valve 38 is disposed at the discharge exit 37. Besides, an annulation 40 is disposed around the surroundings of the inner sidewall of the lower receiving chamber 36 of the upper pot 30. The annulation 40 is inclined so as to form a collecting tank 42. A discharge exit 43 is disposed on the outer sidewall of the upper pot 30 and is adjacent to the collecting tank 42, and a valve 44 is disposed at the discharge exit 43. A coupling seat 46 is placed underneath the lower receiving chamber 36 of the upper pot 30 and extended outwardly from the outer sidewall of the upper pot 30.

The lower pot 50 is placed below the upper pot 30 with a base 52 mounted at its bottom. A receiving space 54-is formed in the interior of the lower pot 50. A plurality of shelve 56 are positioned within the receiving space 54 in the lower pot 50 in order to support a mesh 58. A supporting base 60 is provided at the top of the lower pot 50 and extended outwardly therefrom to mate with the coupling seat 46. Furthermore, an anti-leakage O-shaped ring 65 is provided at the junction of the coupling seat 46 and the supporting base 60 which is beneficial for the prevention of the leakage of the wine steam during the distillation process.

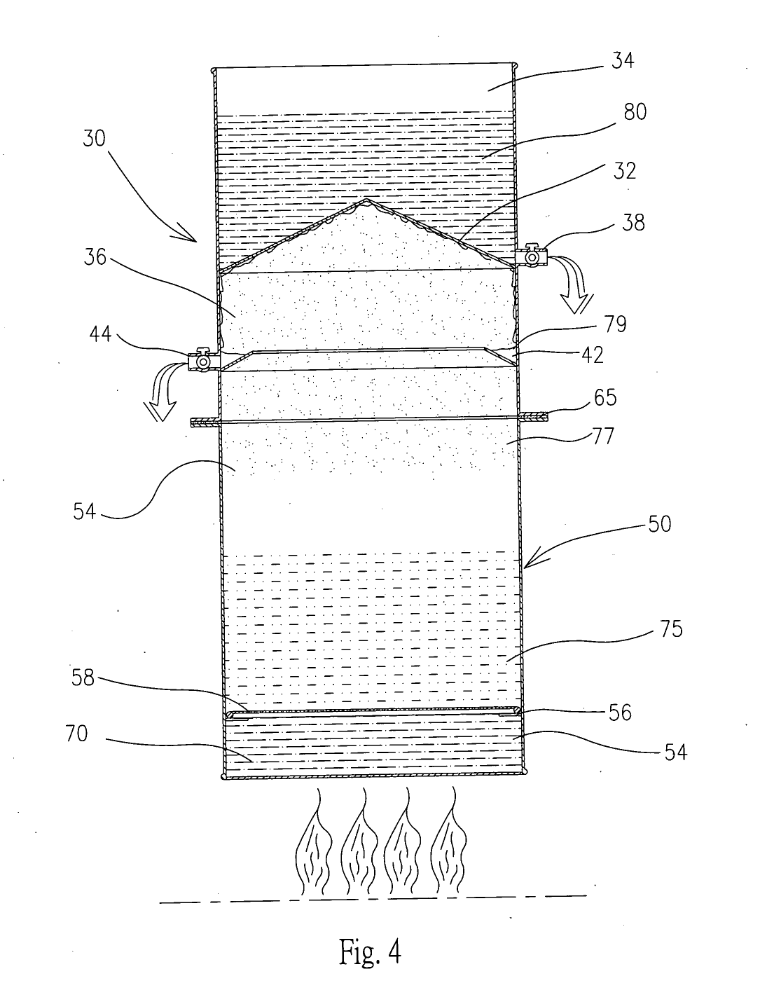

Referring to FIG. 4, the dry distillation process using the inventive distiller will be described in the following. As shown, the receiving space 54 of the lower pot 50 is injected with water 70, wherein the height of water in the receiving space 54 is preferably lower than or equal to the height of the shelve 56. Next, the material to be distilled such as dreggy wine 75 is placed onto the mesh 58, and the upper pot 30 is laid above the lower pot 50. The valve 39 is then closed by a twisting force and the cooling water 80 is injected into the upper receiving chamber 34. Finally, the heater located beneath the lower pot 50 is activated to start the heating process. When the temperature of the distiller is heated up to a certain degree, the dreggy wine 75 will be sublimed gradually to wine steam 77 and pervaded the receiving space 54 of the lower pot 50 and the lower receiving chamber 36 of the upper pot 30.

When the wine steam 77 is diffused to the surface of the cone 32, it will conduct heat exchange with the cooling water 80 contained therein. The wine steam 77 will be condensed into wine liquid 79 which will flow alongside the surface of the cone. 32 and collectively gathered in the collecting tank 42. At this moment, the wine liquid 79 can be injected into the connecting tank 42 as long as the valve 44 is open. However, when the cooling water 80 is conducting heat exchange process and its temperature is as high as up to a certain degree, the valve 38 has to be switched open to discharge the cooling water 80 and replenish the cooling water 80 in order to continuously conduct heat exchange with the wine steam 77. It is noticeable that the present invention takes a brand-new design to contrive a distiller in which an upper pot 30 and a lower pot 50 are introduced so that the cooling water 80 can be directly injected into the upper receiving chamber 34 of the upper pot 30 in order to condense the wine steam 77 into wine liquid 79. Further, the chinks between the upper pot 30 and the lower pot 50 can be avoided by way of the weights of the upper pot 30 and the cooling water 80, and the leakage of the wine steam 77 can be prevented. For the purpose of enhancing the tightness between the upper pot 30 and the lower pot 50, an anti-leakage O-shaped ring 65 is provided at the junction of the upper pot 30 and the lower pot 50, which can facilitate the reduction of the time needed for distillation, increase the amount of distillate, and improve the distilling efficiency. It is to be noted that the inventive distiller is also applicable to refine the essential oils.

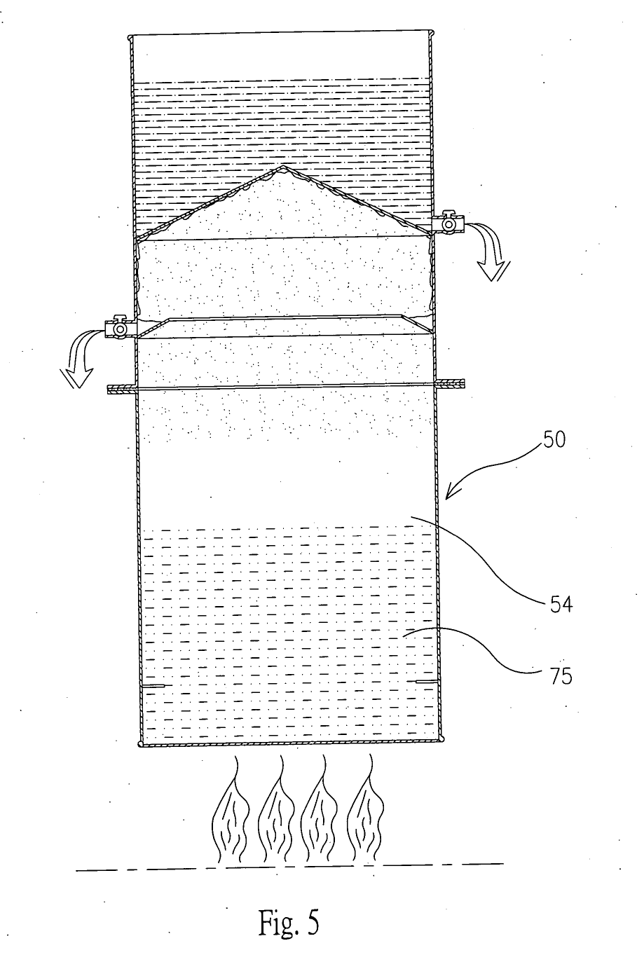

Also referring to FIG. 5, the configuration of the distiller according to the present invention being used in the wet distillation process is shown. As shown, if the distiller according to the present invention is intended to carry out wet distillation, the mesh 58 has to be removed from the receiving space 54 of the lower pot 50. The dreggy wine 75 can be directly placed in the receiving chamber 5, and it is unnecessary to inject water into the receiving space 54. The steps of wet distillation process are the same as those of dry distillation process. In this manner, wet distillation can be accomplished smoothly and the distillate can be derived without effort.

In conclusion, the inventive wet/dry distiller is characterized by that the tightness between the upper pot 30 and the lower pot 50 is reinforced because the weights of the upper pot 30 and the cooling water 80 totally press down upon the lower pot 50, so that the wine steam is prevented from leaking away. The heating efficiency in the distillation process can be enhanced and the time needed for distillation is shortened, and also the amount of distillate is increased significantly.

1. A wet/dry distiller comprising:
an upper pot being a hollow columnar body and having a cone disposed around the surroundings of the inner sidewall of the upper pot so as to divide its inner space into an upper receiving chamber and a lower receiving chamber, wherein the upper receiving chamber and the lower receiving chamber are incommunicable with each other, and wherein an inclined annulation is disposed around the surroundings of the inner sidewall of the lower receiving chamber of the upper pot so as to form a collecting tank, and a discharge exit is disposed on the outer sidewall of the upper pot and is adjacent to the collecting tank; and
a lower pot being a hollow columnar body and placed below the upper pot with a base mounted at its bottom, wherein a receiving space is formed in the interior of the lower pot, and the receiving space is communicable with the lower receiving chamber of the upper pot.

2. The wet/dry distiller according to claim 1 wherein the upper receiving chamber contains cooling water.

3. The wet/dry distiller according to claim 1 wherein a valve is disposed at the bottom of the upper receiving chamber on the outer sidewall of the upper pot.

4. The wet/dry distiller according to claim 1 wherein a valve is disposed at the discharge exit.

5. The wet/dry distiller according to claim 1 wherein an anti-leakage O-shaped ring is further provided at the junction of the upper pot and the lower pot.

6. The wet/dry distiller according to claim 1 wherein a plurality of shelve are positioned within the receiving space of the lower pot in order to support a mesh.

7. The wet/dry distiller according to claim 1 wherein a coupling seat is placed underneath the lower receiving chamber of the upper pat, and an supporting base is provided at the top of the lower 50 and extended outwardly therefrom to mate with the coupling seat.

8. The wet/dry distiller according to claim 1 wherein both of the upper pot and the lower pot are shaped into a cylinder.
